(19) United States
(12) Patent Application Publication
(10) Pub. No.: US 2017/0113549 A1
(43) Pub. Date: Apr. 27, 2017

(54) RUN SCREEN USER INTERFACE FOR AN AGRICULTURAL SYSTEM

(71) Applicant: CNH INDUSTRIAL AMERICA LLC, New Holland, PA (US)

(72) Inventors: Natalia Lucas, Mundelein, IL (US); Bushra Ali, Bensenville, IL (US)

(73) Assignee: CNH INDUSTRIAL AMERICA LLC, New Holland, PA (US)

(21) Appl. No.: 14/923,923

(22) Filed: Oct. 27, 2015

(51) Int. Cl. B60K 35/00; A01B 76/00; A01C 7/08

(52) U.S. Cl. CPC B60K 35/00; A01C 7/08; A01B 76/00; B60K 2350/352

(57) ABSTRACT

An agricultural vehicle system including a vehicle defining a vehicle platform, an implement coupled to the vehicle, and a display. The implement is defined as a type of implement. The display is mounted in the vehicle and is configured with a plurality of areas displayed thereon with a plurality of User Defined Windows (UDWs) on multiple runscreens. Each UDW occupies at least one of the areas. The plurality of UDWs include a set of defined groups being displayed in selected ones of the areas dependent upon both the vehicle platform and the type of the implement.

### BACKGROUND OF THE INVENTION

1. Field of the Invention

The present invention relates to agricultural systems, and, more particularly, to a run screen interface for a display associated with agricultural systems.

2. Description of the Related Art

Farmers utilize a wide variety of implements, including cultivation equipment, seed drills and planters. In a known type of planting implement, seed planting or row units are attached to a toolbar extending transverse to the direction of planting. The toolbar is coupled to a tractor or other work vehicle suitable for pulling the planting implement along a field that is to be seeded to a crop. Each planting unit includes a ground penetrating assembly, often including one or more discs, for opening a seed trench or furrow in the ground as the planting implement is pulled across a field. Components of the ground penetrating assembly shape the bottom and sides of the seed trench, and a seed-metering device provides individual seeds at a controlled rate for deposit in the seed trench. Furrow closing components of each row unit close the seed trench in a controlled manner.

Agricultural planters are commonly used implements to plant seeds in soil. An agricultural planter can include a chassis that carries one or more storage tanks carrying seed, and chemical applications that are to be applied to the field during the planting operation, a hitch mechanism that attaches to a tractor or other implement pulled by a tractor, and a tool bar that row units can be connected to so they are carried by the chassis. The planter can also include a pneumatic system carried by the chassis that supplies pressurized air to transport the seeds or other particulate from the storage tanks to the row units.

Each row unit of the agricultural planter places seeds in the field. Typically, the row units are laterally arranged along a length of the tool bar so that as the planter is pulled across the field, each row unit plants seeds at predefined intervals along the path it is pulled across. To plant seeds, the row units perform four main operations as they are pulled: opening a trench in the soil; placing a seed into the formed trench at appropriate intervals; closing the formed trench to put soil on top of the placed seed; and packing soil on top of the seed to provide desirable soil contact with the placed seed. To open a trench in the soil, a furrowing disc system, also called an opening disc, cuts into the soil and rotates, dislocating soil as it rotates to form the trench.

Once the trench is open, a seed is placed in the trench by a metering device which receives seeds from the main storage tank(s) or a row unit storage tank and typically utilizes a combination of differential air pressure, to select the seed, and gravity to place the seed in the trench at predefined intervals along the pulled path so that adjacent seeds in the row are not too close to one another. One or more closing discs carried behind the furrowing disc are pressed into the soil and also rotate as the planter is pulled to replace soil dislocated by the furrowing disc in the trench or dislocate adjacent soil into the trench to cover the seed placed in the trench with soil. Finally, at least one pressing wheel carried behind the closing disc(s) exerts pressure on the soil covering the seed to press the soil down onto the seed and provide good soil contact with the seed. By having multiple row units working in unison as the planter is pulled across a field, many seeds can be effectively planted in an efficient manner.

Since a variety of tractors can couple to a variety of implements, such as a planter, the capabilities of the controls and availability of information relative to the operation of the implement/vehicle system creates a problem of adequate displays of information and presentation of controls to a user.

What is needed in the art is a robust display that presents information and control options pertinent to the selected vehicle and implement.

### SUMMARY OF THE INVENTION

The present invention provides a user interface that is sensitive to the selection of the towing vehicle and the towed implement.

The invention in one form is directed to an agricultural vehicle system including a vehicle being defined as a vehicle platform, an implement coupled to the vehicle, and a display. The implement is defined as a type of implement. The display is mounted in the vehicle and is configured with a plurality of areas one of which being a Runscreen, displayed thereon with a plurality of User Defined Windows (UDWs). Each UDW occupies at least one of the areas. The plurality of UDWs include a set of defined groups being displayed in selected ones of the areas dependent upon both the vehicle platform and the type of the implement.

The invention in yet another form is directed to a method of displaying information for an agricultural vehicle system having a vehicle that defines a vehicle platform, and an implement coupled to the vehicle, the implement being of one of a defined type of implement. The method includes the steps of dividing a portion of a display area into a plurality of areas; and occupying subsets of the areas with UDWs with each subset of the areas having one UDW associated therewith. The UDWs that are displayed in selected ones of the areas dependent upon both the vehicle platform and the type of the implement.

An advantage of the present invention is that the display areas conform to a matrix set of rules, thereby simplifying the occupying of the areas with UDWs on multiple runscreens.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a perspective view of an agricultural implement in the form of a planter using an embodiment of the runscreen user interface system of the present invention communicatively coupled thereto;

FIG. 2 is a schematic representation of a complete agricultural vehicle system using the implement of FIG. 1 and the runscreen user interface system of the present invention;

FIG. 3 is an example of a runscreen implemented using the present invention;

FIG. 4 is another example of a runscreen implemented using the present invention;

FIG. 5 illustrates subsets of areas that are combined to be used as three individual User Defined Windows;

FIG. 6 illustrates another possibility of subsets of areas that are combined to be used as three other individual User Defined Windows; and

FIG. 7 illustrates the full matrix of areas available in the overall runscreen area.

Corresponding reference characters indicate corresponding parts throughout the several views. The exemplification set out herein illustrates one embodiment of the invention, in one form, and such exemplification is not to be construed as limiting the scope of the invention in any manner.

### DETAILED DESCRIPTION OF THE INVENTION

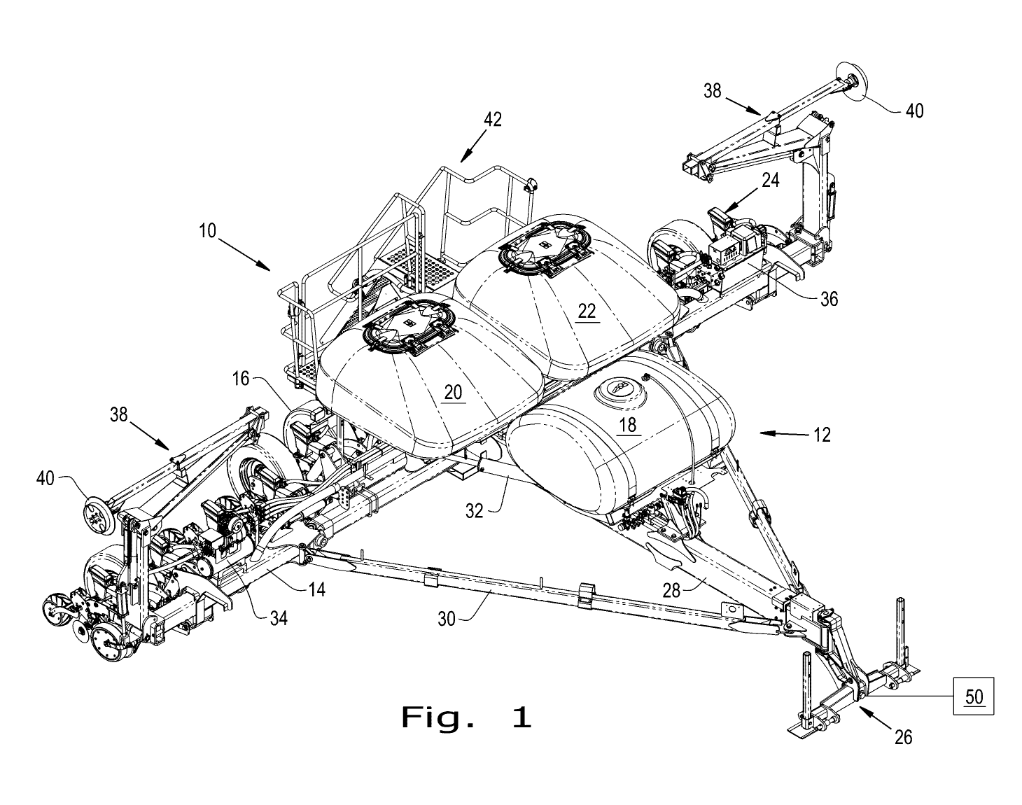

Referring now to the drawings, and more particularly to FIG. 1, there is shown an embodiment of an agricultural planter 10 according to the present invention which generally includes a chassis 12 forming a support structure for components of the planter 10 that can be formed by a hitch assembly at a front of the planter 10 connected to a tool bar 14, main wheels 16 carried by the chassis near a rear of the planter 10, one or more storage tanks 18, 20, and 22 that can be filled with seed or other agriculture material carried by the chassis, and a plurality of row units 24 connected to the tool bar 14 and arranged laterally across a length of the tool bar 14 so that they are carried by the chassis. The chassis 12 can include a hitch 26 configured to be connected to a tractor 50 or other agricultural implement (not shown) so that the planter 10 can be pulled in a forward direction of travel. The hitch 26 can be integrally formed with or connected to a hitch bar 28 that is connected to the tool bar 14 by bracing bars 30 and one or more cylinders 32. As can be seen, the planter 10 can also have various hydraulic, pneumatic, and electrical lines (unnumbered) throughout to support various cylinders and systems that are included on the planter 10, such as a pneumatic system 34 connected to the tool bar 14 and an electric generator 36 also connected to the tool bar 14. A marking device 38 can be connected to each lateral end of the tool bar 14 and extendable so that a marking disc 40 of the marking device 38 can create a line in the soil as the planter 10 is pulled that helps a user in positioning the planter 10 to create subsequent rows. A stair assembly 42 can be mounted to the back of the planter 10 to allow for an operator to access the storage tanks 20, 22.

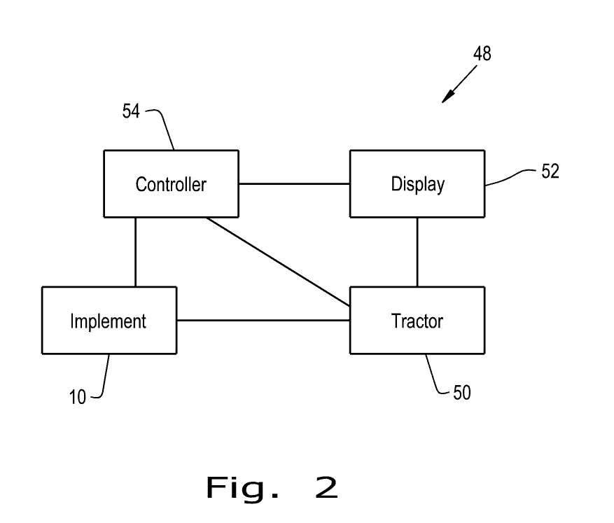

Now, additionally referring to FIG. 2 there is shown a schematic representation of an agricultural vehicle system 48 that includes tractor 50 coupled to implement 10. While a planter is shown in detail it is to be understood that any agricultural implement can be utilized. Further, although a towing of implement 10 by tractor 50 is illustrated herein it should be understood that tractor 50 may be any agricultural, construction, or forestry vehicle that is can be coupled to various implements 10.

FIG. 2 additionally illustrates that a display 52 is incorporated in tractor 50 and display 52 is an interactive display 52 configured to provide information to a user and allow the user to direct the operation of tractor 50 and/or implement 10. A controller 54 receives information from sensors on implement 10 and tractor 50, processes, stores and displays selected portions of the information. The displaying of information and control features on display 52 takes into account that a selected area of display 52 is set aside to display runscreens.

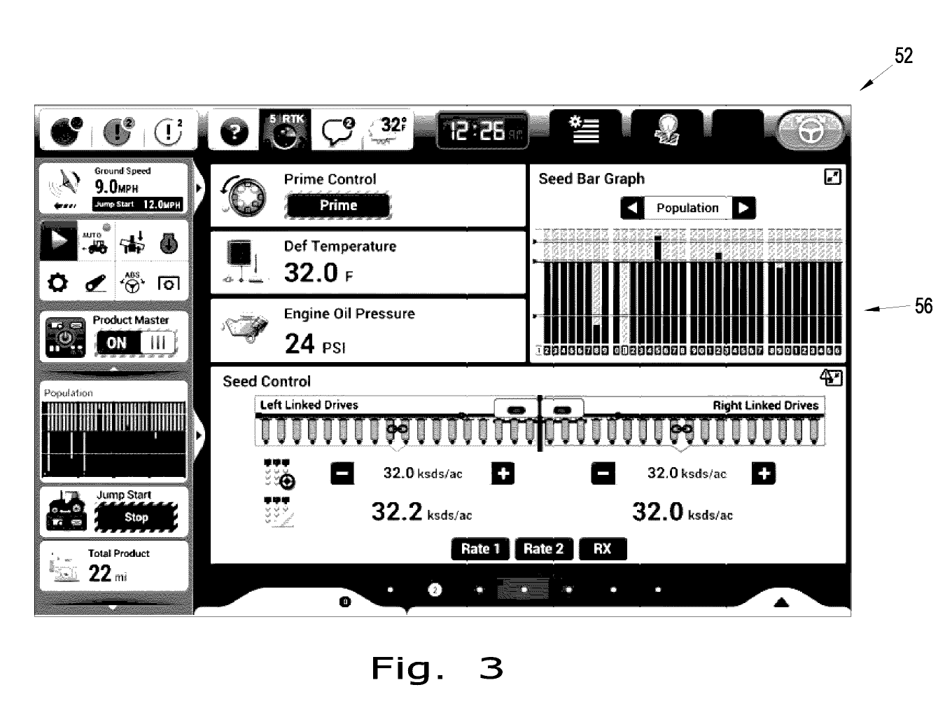

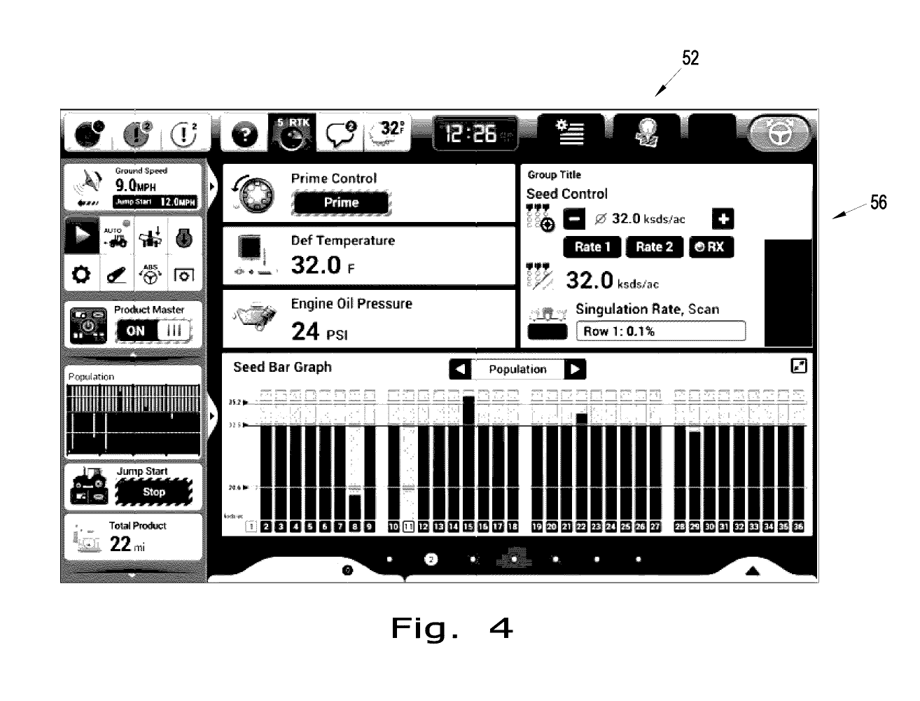

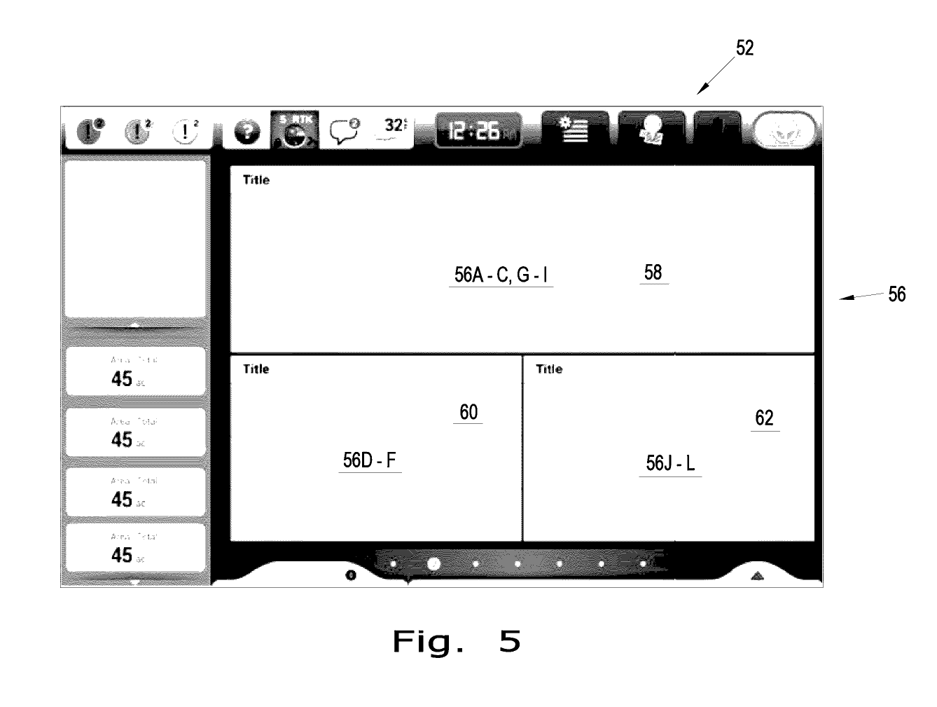

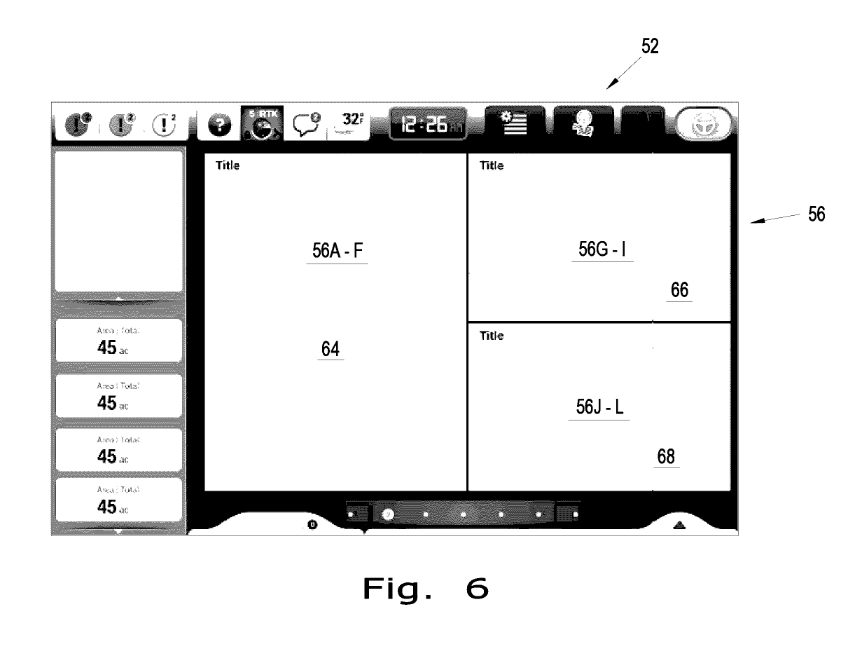

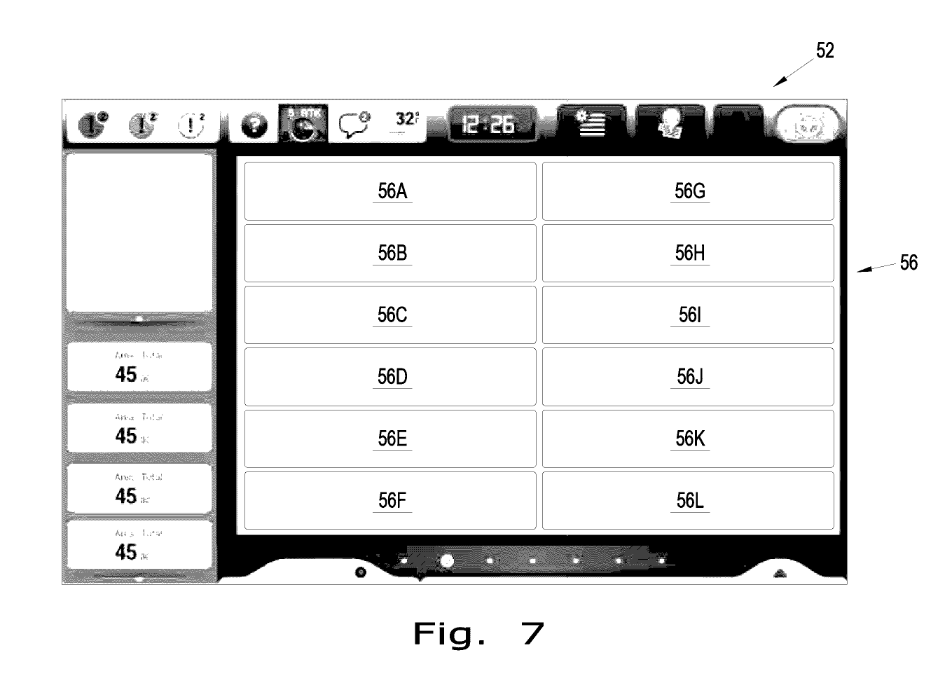

Now, additionally referring to FIGS. 3-7, there are shown some runscreen areas 56 that illustrate the inventive aspect of the present invention. The runscreen areas 56 of FIGS. 3 and 4 are the portion of display 52 that is different in each of these Figs. This portion is a matrix of areas, which may be most easily seen in FIG. 7 where areas 56A-L are shown which represent a 6×2 matrix of areas. The runscreens of FIGS. 3 and 4 are a subset of this matrix. The selection of subsets of areas 56A-L can be seen clearly in FIGS. 5 and 6.

In FIG. 5, areas 56A-C, G-I are taken up by one User Defined Window (UDW) 58, which is similar in size as the bottom UDWs shown in FIGS. 3 and 4. This full width UDW 58 takes up a 3×2 subset of the 6×2 matrix 56. Then two smaller UDWs 60 and 62 each are a subset of three areas 56D-F and 56J-L respectively. UDWs 60 and 62 each are a 3×1 subsets of matrix 56.

In FIG. 6 three UDWs 64, 66 and 68 are illustrated with UDW 64 using areas 56A-F, UDW 66 using areas 56G-I, and UDW 68 using areas 56J-L. Stated differently, UDW 64 uses matrix 56 cells 56A-F, UDW 66 uses matrix cells 56G-I, and UDW 68 uses matrix cells 56J-L. UDW 64 is a 3×2 matrix, and UDWs 66 and 68 are each 3×1 matrixes.

In runscreen area 56 the UDWs are selected to be displayed in a contiguous subset of the twelve cells 56A-L of the matrix of runsreen area 56. The full set of areas is illustrated in FIG. 7 that are available for selection in some combination to display runscreens.

In the illustrations of the present invention FIG. 3, planter 10 is shown in operation with planting populations being displayed in a UDW in areas 56G-I (see FIG. 7 for area definitions). Operational information relative to tractor 50 is displayed as a UDW in areas 56A-C. A UDW in areas 56D-F and J-L is a depiction of planter 10 used to illustrate the functioning of planter 10 along with a measure of the left and right drives and their associated seed counts per acre.

In FIG. 4 the UDW that was in areas 56G-I (FIG. 3) now occupies areas 56D-F and J-L allowing an easier viewing of the performance of each row unit, with row unit 8 underperforming, and row unit 11 being inoperable. In the upper left portion of runscreen 56 there are three UDWs that respectively occupy cells 56A-C. The UDWs shown on display 52 being representative of those available because of the ability of the present invention to select the UDWs based on the type of vehicle 50 and implement 10 that are connected and utilizes the rules associated with the UDW areas 56A-L. Control options and information may vary depending on the resizing of the UDWs.

Runscreen areas 56 is the centerpiece of display 52, taking up most of the area of display 52. This allows direct access to the controls that users need daily in order to efficiently operate the tractor 50/implement 10 combination. The runscreen can have multiple pages, for example 7 pages, and the user can navigate through the pages by swiping the runscreen area 56 or by taping on the page controls in the bottom bar. The runscreen pages come with default UDW configurations for each type of type of vehicle 50 configuration, and each UDW is highly customizable. The UDWs and groups of UDWs can be either predefined by the system or created by the user.

The predefined UDW groups are different for each vehicle 50 and implement 10 type, with the vehicle 50 platform and the implement 10 type defining which UDWs are available to the agricultural system 48, which is dependent upon that unique combination of vehicle 50 and implement 10. The user defined groups of UDWs associated with agricultural system 48 can be created in an edit screen layout mode, and the UDWs can be organized in tabs.

The user can swipe the UDWs to look for information and it is a customizable user experience, where the user can select the group of information which is most important and valuable to that user. Users can set up a dedicated runscreen to any specific feature, for example maps, planting etc. or can divide the runscreen into two (or more) sections so that multiple different setup or status information is displayed on one screen without the need to navigate between screens.

The runscreen area 56 has a layout that follows the following rules:
1. The entire runscreen area 56 is divided into a grid of 12 cells in the form of a 6×2 matrix 56A-L;
2. The size of a single cell accommodates the smallest UDW (1×1);
3. Multiple UDW's can exist in one or a group of cells;
4. Single UDWs do not have to have a title;
5. A group together with the group title covers exactly the same number of cells as the UDWs that form the group would cover together if arranged vertically one after another; and
6. The groups can be organized in tabs.

UDW (User Defined Windows)
1. The smallest UDW can cover only one cell (1×1) while the biggest can cover the whole runscreen area 56 (all 12 cells);
2. The UDW's can have different sizes, which have to snap to the cell grid (such as 1×1, 1×3, 2×3 etc.).

Groups of UDWs
1. The groups of UDWs are either predefined by the system or created by the user. The predefined groups are different for each vehicle, and
2. Implement type and are defined by the vehicle platform. The user-defined groups of UDWs can be created in an Edit Screen Layout Mode; and
3. The groups of UDWs can be organized in tabs.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An agricultural vehicle system, comprising:
a vehicle defining a vehicle platform;
an implement coupled to said vehicle, said implement being of one of a type of said implement; and
a display mounted in said vehicle, said display being configured with a plurality of areas displayed thereon with a plurality of User Defined Windows (UDWs), each UDW occupying at least one of said areas, said plurality of UDWs including a set of defined groups being displayed in selected ones of said areas dependent upon both said vehicle platform and said type of said implement.

2. The agricultural vehicle system of claim 1, wherein said plurality of areas is a matrix of said areas with at least two rows of said areas.

3. The agricultural vehicle system of claim 2, wherein said matrix has six rows.

4. The agricultural vehicle system of claim 3, wherein said matrix is a 6×2 matrix.

5. The agricultural vehicle system of claim 2, wherein said UDWs each occupy at least one cell in said matrix.

6. The agricultural vehicle system of claim 5, wherein at least one of said UDWs also occupies at least one adjacent cell in said matrix.

7. The agricultural vehicle system of claim 5, wherein at least one of said UDWs also occupies at least two adjacent cells in said matrix.

8. The agricultural vehicle system of claim 5, wherein at least one of said UDWs occupies four contiguous cells in said matrix.

9. The agricultural vehicle system of claim 5, wherein at least one of said UDWs occupies six contiguous cells in said matrix.

10. The agricultural vehicle system of claim 1, wherein at least one of said UDWs occupies an entire runscreen.

11. A method of displaying information for an agricultural vehicle system having a vehicle that defines a vehicle platform, and an implement coupled to the vehicle, the implement being of one of a defined type of implement, the method comprising the steps of:
dividing a portion of a display area on a display into a plurality of areas;
occupying subsets of said areas with User Defined Windows (UDWs) with each subset of said areas having one UDW associated therewith, said UDWs that are displayed being displayed in selected ones of said areas dependent upon both the vehicle platform and the type of the implement.

12. The method of claim 11, wherein said plurality of areas is a matrix of said areas with at least two columns of said areas.

13. The method of claim 12, wherein said matrix has six rows.

14. The method of claim 13, wherein said matrix is a 6×2 matrix.

15. The method of claim 12, wherein said UDWs each occupy at least one cell in said matrix.

16. The method of claim 15, wherein at least one of said UDWs also occupies at least one adjacent cell in said matrix.

17. The method of claim 15, wherein at least one of said UDWs also occupies at least two adjacent cells in said matrix.

18. The method of claim 15, wherein at least one of said UDWs occupies four contiguous cells in said matrix.

19. The method of claim 15, wherein at least one of said UDWs occupies six contiguous cells in said matrix.

20. The method of claim 11, wherein a set of UDWs define a runscreen, with multiple runscreens being separately selectively displayed on the display.
